(19) United States
(12) Patent Application Publication
(10) Pub. No.: US 2008/0207227 A1
(43) Pub. Date: Aug. 28, 2008

(54) Method and System for Determining a Paging Zone in a Wireless Network

(75) Inventors: Hong Ren, Kanata (CA); Carl Cao, Nepean (CA); Alfred Schmidt, Calgary (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: NORTEL NETWORKS LIMITED, St. Laurent, QC (CA)

(21) Appl. No.: 11/814,980

(22) PCT Filed: Jan. 27, 2006
(86) PCT No.: PCT/CA06/00106

§ 371 Date: Jul. 27, 2007

Related U.S. Application Data
(60) Provisional application No. 60/648,185, filed on Jan. 28, 2005.

(51) Int. Cl. H04Q 7/20

(52) U.S. Cl. 455/458

(57) ABSTRACT

A method of paging a mobile terminal in a radio access network wherein the last known location of a mobile terminal is stored. A location message (also called a Route Update message) is sent from a terminal and received at a sector in the network, identifying the location of the terminal. The network determines a paging zone for that terminal based on configuration information for that sector. The configuration information for each sector typically includes a Route Update radius, and then one or both of a paging zone radius offset, and statically configured sectors. When the terminal needs to be paged, the network then broadcasts a page to the terminal in each sector in the paging zone. Such a system adjusts the paging zone to include sectors which the terminal has a reasonable likelihood of moving to before the network learns that the terminal has moved out of the previously established paging zone. Aspects of the invention provide two complementary methods of adjusting the paging zone: adjusting using a paging zone offset, and adjusting based on a sector list. The paging zone offset adjusts the radius of the paging zone, thereby maintaining a generally circular shape. The sector list adjusts the generally circular paging zone by adding or deleting any sector in any direction, thereby allowing any arbitrary shape to be used for the paging zone. The adjustments to the paging zone achieved by these methods account for such factors as RF coverage, geographic features, congestion, population density and expected rate of movement of terminals between sectors.

### CROSS REFERENCE TO RELATED APPLICATIONS

This application claims the benefit of priority of U.S. Provisional Patent Application No. 60/648,185 filed Jan. 28, 2005, which is incorporated herein by reference.

### FIELD OF THE INVENTION

The present invention relates generally to wireless networks. More particularly, the present invention relates to paging mobile terminals in wireless networks.

### BACKGROUND OF THE INVENTION

As many wireless terminals are mobile, the wireless network will not always know in which sector a terminal is located at any given time. Normally, the terminal informs the network of a change in its location only when it moves from one subnet (a relatively large geographical zone covering many sectors) to another subnet. Although it would be technically possible for the terminal to inform the network every time it moves between sectors, this is not practical, because the frequency of such updates would consume a large amount of processing and message transmission resources. Instead, most wireless network try to locate a mobile terminal only when there is traffic to send to the terminal, by “paging” the terminal in all the sectors of the subnet.

In order to better utilize the network resources, prior art methods have proposed to only page a terminal in the sector from which it had last transmitted a message to the network, and the surrounding sectors. Furthermore, to account for mobility, the prior art methods have proposed that the terminal sends location update messages (typically called route update messages) to the network to inform the network of its location after the terminal has moved a defined distance, or after it crosses a defined boundary. In either case, the terminal typically defines its location as the geographical coordinates of the sector that it sees with the best radio frequency (RF) signal. The surrounding sectors to which pages are sent consists of the cells that lie within the distance or boundary beyond which the terminal needs to send its location updates.

Such an approach conserves network resources, but is not always reliable, as the terminal may have moved beyond the paging range of the surrounding cells, before it sends successfully its location update message and the network updates the paging range accordingly. In such a circumstance, any page destined for the terminal prior to the terminal sending its next location update message will not be received.

It is, therefore, desirable to provide a system which presents a better trade-off between reliability and conserving resources.

### SUMMARY OF THE INVENTION

A first aspect of the invention provides a method of paging a mobile terminal in a wireless network. According to this aspect a location message (also called a Route Update message) is sent from a terminal and received at a sector in the network, identifying the location of the terminal. The network determines a paging zone for that terminal based on configuration information for that sector. The configuration information for each sector typically includes a Route Update radius, and then one or both of a paging zone radius offset, and statically configured sectors. When the terminal needs to be paged, the network then broadcasts a page to the terminal in each sector in the paging zone.

Such a system provides a better trade-off between the reliability of pages being successfully received by the terminal and conserving resources compared to prior art techniques. Such a system adjusts the paging zone from prior art distance based paging techniques to include sectors which the terminal has a reasonable likelihood of moving to before the network learns that the terminal has moved out of the previously established paging zone.

Aspects of the invention provide two complementary methods of adjusting the paging zone: adjusting using a paging zone radius offset, and selecting sectors based on a sector list. The paging zone offset adjusts the radius of the paging zone, thereby maintaining a generally circular shape. The sector list adjusts the generally circular paging zone by adding or deleting selected sectors from the paging zone based on a sector list established for each sector. This allows sectors to be adjusted in any direction, thereby allowing any arbitrary shape to be used for the paging zone. The adjustments to the paging zone achieved by these methods account for such factors as RF coverage, geographic features, congestion, population density and expected rate of movement of terminals between sectors.

A further aspect of the present invention provides a method of establishing a paging zone for a terminal in a wireless access network comprising: a) including in the paging zone the sector which receives the last location update from said terminal; b) including in the paging zone sectors located within a determined distance from said sector; and c) adjusting the sectors included in the paging zone based on criteria stored for said sector. The determined distance is the distance the terminal is allowed to travel before notifying the network of its current location. The paging zone initially defined by this distance can then be adjusted in a circular manner, a non-circular manner, or both. For example, the distance can be adjusted in a circular manner by defining the to criteria include an offset distance and said step of adjusting comprises including sectors located within a distance from said sector equal to said determined distance modified by said offset distance. The paging zone can be adjusted in a non-circular manner by adding or subtracting specific sectors based on said criteria, wherein said criteria depends on such factors as geographic features, congestion, population density and expected rate of movement of the terminal.

A further aspect of the present invention provides a method to construct more than one paging attempt. In the first attempt, a smaller paging zone radius offset may be used, and one set of added sectors, subtracted sectors, or both are included. In subsequent attempts, an increased paging zone offset may be used, and another set of added sectors, subtracted sectors or both are included. Accordingly more than one paging zone can be established for a terminal, with a different paging zone for each subsequent paging attempt.

In a further aspect there is provided a System for paging a mobile terminal in a Radio Access Network (RAN), said RAN including a processor and a software product stored on a machine-readable medium which when executed by said processor carries out the methods as described.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic diagram illustrating a potential paging zone for a cellular network.

FIG. 2 is a schematic diagram illustrating another paging zone for a cellular network.

FIG. 3 is a schematic diagram illustrating another paging zone for a cellular network.

FIG. 4 is a flowchart illustrating a process according to one embodiment of the invention.

### DETAILED DESCRIPTION

Generally, the present invention provides a method and system for reliably paging a terminal while conserving wireless network resources.

In the following description, for purposes of explanation, numerous details are set forth in order to provide a thorough understanding of the present invention. However, it will be apparent to one skilled in the art that these specific details are not required in order to practice the present invention. For example, specific details are not provided as to whether the method is implemented as a software routine, hardware circuit, firmware, or a combination thereof.

Embodiments of the invention may be represented as a software product stored on a machine-readable medium (also referred to as a computer-readable medium, a processor-readable medium, or a computer usable medium having a computer readable program code embodied therein). The machine-readable medium may be any type of magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data. Those of ordinary skill in the art will appreciate that other instructions and operations necessary to implement the described invention may also be stored on the machine-readable medium. Software running from the machine readable medium may interface with circuitry to perform the described tasks.

We will discuss embodiments of the invention in relation to the example implementations for CDMA 1xEV-DO networks. However, the invention is also applicable to other wireless networks such as 1xRTT, GSM, UMTS, IEEE 802 and PHS. We will first provide some background information describing an example wireless network. In reading this specification, the reader may find the listing of acronyms in Table 1 a useful resource.

TABLE 1

| | |
|---|---|
| 1xEV-DO | 1xRTT Evolution Data Optimized |
| 1xRTT | 1x Radio Transmission Technology |
| AT | Access Terminal |
| BTS | Base Station Transceiver System |
| CDMA | Code Division Multiple Access |
| GGSN | GPRS Gateway Serving Node |
| GPRS | General Packet Radio System |
| HRPD | High Rate Packet Data (also referred to as 1xEV-DO) |
| HSDPA | High Speed Downlink Packet Access |
| HSUPA | High Speed Uplink Packet Access |
| MS | Mobile Station |
| Node.B | UMTS terminology for BTS |
| PDSN | Packet Data Serving Node |
| RAN | Radio Access Network |
| RNC | Radio Network Controller |
| RUR | Route Update Radius |
| UMTS | Universal Mobile Transmission System |

A Wireless Network such as a HRPD network (or a 1xRTT or a UMTS network) consists of a packet data network access gateway, i.e., a PDSN in the HRPD network (or a GGSN in a UMTS network) and a Radio Access Network. The subscriber device, which is typically a wireless terminal, is referred to as an AT (or a MS).

The Radio Access Network (RAN) comprises Radio Network Controllers (RNCs), and a plurality of base station (BTS) nodes. The BTS transmits radio signals in the area surrounding the antenna of the BTS, called a cell. Typically each cell is subdivided into 3 sectors by using directional antennas. Each RNC typically controls a plurality of BTS nodes. A subnet comprises a RNC, the BTS nodes controlled by the RNC, and the cells/sectors controlled by the BTS.

When an AT is in dormant state (i.e., it does not have a traffic channel established with the RAN), and the RAN needs to communicate with the AT, the RAN (the RNC and the BTSs) composes a page that is transmitted to the AT on a shared overhead channel. The page prompts the AT to initiate the setup of a traffic channel and to report its current location. As opposed to the dormant state, the AT is in a connected state once the traffic channel is established between the AT and the RAN.

The geographical distribution of the RNC and the BTS nodes are designed to cover the geographical area of the subnet with radio transmission such that whenever the AT is within the subnet it can communicate to the RNC through one or more sectors of a BTS. In fact, in the connected state, the AT may be communicating with sectors belonging to more than one BTS node over a dedicated traffic channel with each sector.

As stated above, the most reliable system for paging a terminal is to broadcast the page in all sectors of the subnet. However, as stated above, this is wasteful of network resources. In order to limit the sectors which broadcast a page to a given terminal, an operator can limit such page messages to a paging zone (also called a paging radius or paging area) representing a geographic area in which the terminal is likely to be located. For 1xRTT, a paging zone can be constructed as a list of sectors configured by an operator through Operations, Administration, Management and Provisioning (OAM&P) tools. The 1xRTT concept is to subdivide the network into a set of non-overlapping paging zones, where each zone consists of a set of non-overlapping Cell ID's. The key point here is that a zone list is shared by all Cell ID's in that zone, instead of having an independent paging zone for each Cell ID. To choose a zone for sending a page, the 1xRTT RAN looks up which zone contains the Cell ID where the terminal was last seen (either by a Registration message or a call origination/termination).

The problem with this method is that the paging success rate is relatively low if only one paging zone is paged, particularly when a mobile was last seen at the paging zone boundary. Thus such a system has sacrificed reliability (in terms of paging success) in order to conserve network resources.

We will discuss exemplary embodiments which provide new methods of establishing paging zones using examples relating to a 1xEV-DO RAN. The 1xEV-DO airlink standard (TIA-856) defines a parameter called a RouteUpdateRadius, which is a distance limit used by an access terminal (AT) to decide when to notify the RAN of its new location. Essentially, if the distance between the current serving sector and the sector in which the AT last updated its location is greater than the RouteUpdateRadius, the AT notifies the RAN of its location by sending a RouteUpdate message.

In 1xEV-DO, the paging zone can be constructed dynamically as a list of sectors that are located within the circular area defined by the RouteUpdateRadius of the sector that received the last RouteUpdate message and the geographic location of that sector. In other words, once the locations of all sectors and their route update radii are configured, the network can calculate automatically a paging zone for each sector, where the paging zone consists of all sectors whose geographic locations lie within the route update radius of the sector. The access network can then limit the transmission of its initial pages for a given terminal to be paged to occur only in the sectors listed in the paging zone of the sector that received the last RouteUpdate message from that terminal, or the sectors that were part of the terminal's last traffic connection in the case where the RouteUpdate was sent in the connected state. Note that in connected state, the terminal can be simultaneously using traffic channels from multiple sectors in the process referred to as soft handoff.

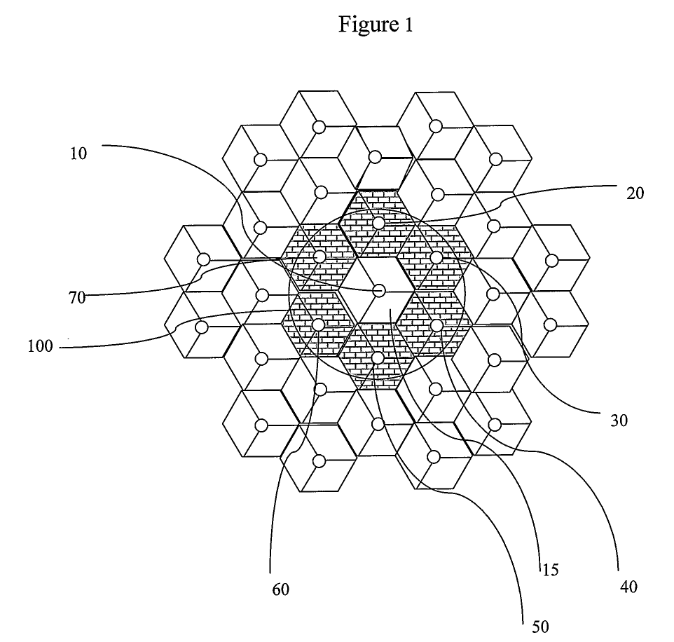

Such a system is illustrated in FIG. 1. In this figure, each hexagon represents a cell with three sectors. The small circle indicates the basestation antenna at the center of the cell. Here the terminal was last seen in the center cell 10 which includes the sector 15 in which the access terminal last reported its location.

As a terminal moves to a different sector it will “acquire” (i.e., it will receive overhead messages from an antenna in) the new sector and listen to its overhead messages. As the terminal moves further, it will acquire other new sectors. When it moves far enough that it acquires a sector whose geographic location is further than a RouteUpdateRadius (RUR) from the sector where the terminal last reported its location, the terminal sends a RouteUpdate message to the BTS that controls the new sector advising the network of its new location, i.e., which sector the AT has acquired.

With this approach, all the sectors that are located within the circular area defined by the RouteUpdateRadius of the sector 15 will be included in the paging zone. Hence, in FIG. 1, the paging zone includes the center cell 10 and all of the surrounding cells highlighted with the brick pattern 20, 30, 40, 50, 60, and 70. When a terminal moves outside of the RouteUpdateRadius defined in the sector where the terminal last reported its location, the terminal sends a Route Update message so that the network can redefine the paging zone for that terminal based on its new location.

In theory, the system would only need to page the sectors within the paging zone as defined to reach the terminal. However, we have found that this is not always reliable, and pages are missed using such an approach. For example, we have found there is often a delay between the terminal moving outside of the paging zone and network receiving a Route Update message from the terminal. This can be due to the terminal's internal delay before it sends the Route Update message. Also, when a mobile arrives at a sector outside its RUR, it uses the reverse link access channel to send the Route Update message.

However, this channel can be congested, as other terminals compete for the same channel. Therefore there can be a delay before the terminal successfully transmits it's Route Update message. If a page is sent to the paging zone defined only by the RouteUpdateRadius during this period of time, the terminal will not receive the page. In addition, successful reception of the Route Update message is not guaranteed. The terminal will attempt to send it, but the message may or may not be successfully received by the network. Furthermore even though the Network may have the BTS send an ACK to the terminal to indicate that the access channel packet containing the Route Update Message was received, there can be delays between the BTS sending the ACK and the paging zone being actually updated. The ACK message is generated by a low layer protocol (the Access Channel Medium Access Control protocol), but the RouteUpdate message is processed by a higher layer protocol (the Route Update protocol). For example, in some embodiments, the ACK may be generated locally at the BTS before the BTS sends the message to the Radio Network Controller (RNC), which processes the RouteUpdate message and updates the paging zone. In addition to delays between the BTS sending the ACK and the RNC processing it; it is possible that the message can be lost in the backhaul (or transport) network between the BTS and the RNC.

In addition, asymmetries in the RF coverage, e.g. path loss, may prevent the terminal from notifying the network over the RL access channel even though it has acquired the forward signal from another base station.

Furthermore, a terminal needs only to comply with a certain defined accuracy of computing its RUR in the wireless technology standards (CDMA 1xEV-DO airlink standard TIA-856 defines this accuracy to be within error of no more than +1-5% or +/−7% under different conditions). Vendor specific implementations, simplifications, or both may result in variations between different AT that may decide it has not exceeded the RouteUpdateRadius even though in cases it has moved beyond it.

In short, it is possible that the Route Update message is sent with some delay and/or it is not timely processed and/or the decision to send it is made at a location that is further than expected. Therefore the terminal can move outside the paging zone before the network is updated to reflect the terminal's current position, if the paging zone is restricted to only the surrounding sectors/cells within the RouteUpdateRadius. Accordingly, preferred embodiments of the invention extend the paging zone to decrease the likelihood that a page will be sent to a terminal out of range of the RouteUpdateRadius. Accordingly, embodiments of the invention expand the paging zone to include additions cells (called offset cells), in order to increase the reliability of the pages being reached by the terminal. In order to increase the reliability of successful pages to terminals in these cases, some sectors that are not located within the circular area defined by the RouteUpdateRadius are included in (i.e., added to) the paging zone. Embodiments of the invention adjust the paging zone in two ways, which can be used either individually or together:
a) by defining a paging zone radius offset to increase the radius of the circular area used to select sectors for the paging list. Basically, the paging zone radius will not be the same as the RouteUpdateRadius. It will be the sum of the RouteUpdateRadius and the paging zone radius offset.
b) by configuring a list of sectors to be added to (and/or subtracted from) the paging zone.

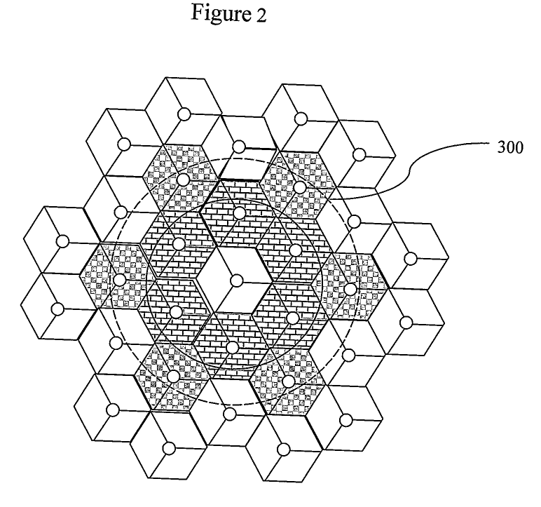

FIG. 2 illustrates an expanded paging zone according to an embodiment of the invention. FIG. 2 differs from FIG. 1 in that additional cells outside of the RouteUpdateRadius are highlighted (with a square pattern). These additional highlighted cells are included to be part of an extended paging zone, due to their proximity to the cells within the RouteUpdateRadius. These cells have a higher likelihood of being within the area that the mobile may move to before the network successfully processes any RouteUpdate message sent by the terminal. Thus an extended paging zone includes the cells from FIG. 1, plus these cells. In the example shown, cells whose coverage extends into the circular area, but are not themselves included in a paging zone defined by the circle 100, are now included in an extended paging zone 300. The new paging zone is a circular area with a paging zone radius being the RouteUpdateRadius plus the paging zone radius offset.

Note that FIG. 2 only includes the cells whose antennas are within the circle 300 in the extended paging zone. Other neighbouring cells are not located within the paging zone, and are thus not paged, as shown. However, if increased reliability is desired, these neighbouring cells, or even additional cells can be included in the paging zone, or the offset radius can be extended. Furthermore, the paging zone can be configured in terms of individual sectors rather than cells. Note that technically it is the advertised geographic location of the BTS antenna which is used for location determination. Typically this is coterminous with the antenna's physical location.

Once the network processes a RouteUpdate message received from a terminal, it determines the sector in which the terminal is located. Note that the Route Update message may be included with other messages sent by the terminal. Each sector can be configured with its own RouteUpdateRadius and paging zone radius offset. Each sector advertises its RouteUpdateRadius to terminals in its RF coverage area over a shared overhead channel. The terminal stores the RouteUpdateRadius of the sector where it last sent a RouteUpdate message. As the terminal moves to new sectors, it receives the RouteUpdateRadius values from the new sectors, but it does not store the new RUR value, unless the distance between the new sector and the sector where the last RouteUpdate message was sent exceeds the RouteUpdateRadius currently stored by the terminal. Thus, the automatic update consists of 2 parts: the terminal updating its stored RouteUpdateRadius only when it sends a RouteUpdate message, and the RAN updating its stored Paging Zone for that terminal based on the RouteUpdateRadius and Paging Zone Offset of the sector where the new RouteUpdate message is received.

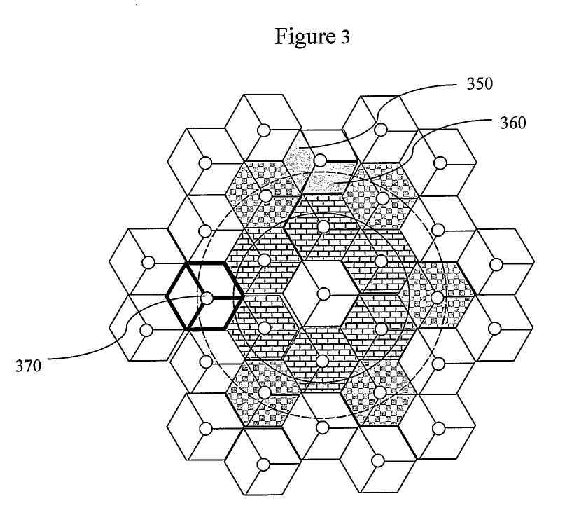

As an optional feature, FIG. 3 illustrates another paging zone, according to another embodiment of the invention. Here static configuration by the operator can adjust the paging zone by either adding or subtracting particular sectors (or cells). These changes may be made due to knowledge of the capacity demands and geographic area surrounding particular cells. For example, assume that the last known location of a terminal is proximate to a major highway in a rural area. Let us also assume that there is a river nearby, with no bridge or ferry service in the vicinity. In such circumstances, the operator may configure additional sectors (or cells) along the path of the highway to be added to the paging zone, to take into account the probable directions of the mobile terminal, and the fact that it is likely moving at high speeds along the highway. Similarly, the mobile is unlikely to cross the river, so sectors (or cells) on the other side of the river can be removed from the paging zone. This may be particularly beneficial if there is a town on the other side of the river which has high demand for wireless resources in the area. Under certain circumstances, an operator may wish to adjust the paging zone by adding or subtracting sectors (or cells) for capacity reasons. For example, an operator may be planning on adding a “hot zone” to a particular area suffering from call blocking due to insufficient capacity to meet the demand. Until such a hot zone is installed to add the needed capacity, an operator may wish to remove such sectors (or cells) from the paging zone. Thus FIG. 3 differs from FIG. 2 by showing sectors 350 and 360 (the shaded sectors) are added and the highlighted cell 370 no longer includes the square pattern to show it has been removed from the paging zone.

There can be other reasons to modify the paging zone by including or excluding sectors. For example, in a valley, the closest BTS may not be the best BTS to serve a terminal. The terminal may be better served by a BTS with a clear line of sight than the closest BTS whose transmissions may be obscured by hills or mountains. Therefore it can be advantageous to add this sector to a paging zone, even though it is outside of the circle defined by the paging zone radius (plus offset if used).

So geographic features, congestion, population density and expected rate of movement are all examples of factors that can be considered in fine tuning the sectors to be included (or excluded) to adjust the paging zone in a non-circular manner. The geographic features can include line of sight considerations, borders, rivers, roads, etc.

FIG. 3 illustrates one example of how operators can modify the paging zone list that is built dynamically by configuring a static list of sectors that they want either added to the circular area or excluded from the circular area. In addition, such a system allows the operator to define a paging zone radius offset (a positive or negative distance) that is added to the RouteUpdateRadius to calculate the effective radius of the circular paging area.

Hence, the enhanced paging zone is the set of sectors formed by combining the dynamic sectors that are located within the circular area determined by the effective paging zone radius (i.e., the RouteUpdateRadius plus the paging zone radius offset), plus the list of sectors that the operator wants added individually, minus the sectors that the operator wants excluded individually. The resulting enhanced paging zone is no longer constrained to be a circular area.

Note the size of the paging zones may not be uniform—the operator can engineer a different paging zone for each cell or sector. For example downtown areas may use smaller route update radii than rural areas; so the offsets will be adjusted accordingly, depending on whether it is a high or low density area.

So according to this embodiment of the invention, the Paging Zone includes the cells or sectors which are within a circular area defined by a radius of RUR plus the paging zone radius offset; plus individually selected sectors. Such a paging zone is established/configured for each sector, for example by storing the relevant information regarding size of radii, offsets and sectors to be individually adjusted for each sector. Alternatively, an operator can configure all sectors uniformly for radius and offset.

Such a paging zone with the zone offset and “Add/Remove” sectors can either be pre-computed and stored or computed dynamically as needed. Typically the operator will configure a table identifying the paging zone (the RouteUpdateRadius, paging zone radius offset, and individually selected sectors) for each sector. A common (or default) table can be applied to many or all sectors, and individual tables can be configured per sector (where the per sector tables would override the common table). Note that the process of determining whether a sector is paged (i.e., is included in the paging zone) can be centralized (at the RNC) or distributed (e.g., at the BTSs).

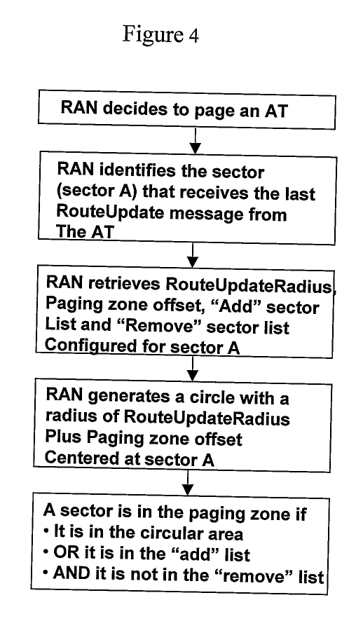

FIG. 4 illustrates a flowchart of the method steps executed by a processor of the network, according to an embodiment of the invention, to determine the Paging Zone for an access terminal (AT).

The enhanced paging zone can be applied to all frequency channels of the RAN uniformly, or it is also possible to create one enhanced paging zone per subset of frequency channels. This latter case might be appropriate in deployments where subsets of ATs are segregated to operate on different subsets of frequency channels based on operator policy and/or AT capability.

The above-described embodiments of the present invention are intended to be examples only. Alterations, modifications and variations may be effected to the particular embodiments by those of skill in the art without departing from the scope of the invention, which is defined solely by the claims appended hereto.

1. A method of establishing a paging zone for a terminal in a wireless access network comprising:
a) including in the paging zone the sector which receives the last location update from said terminal;
b) including in the paging zone sectors located within a determined distance from said sector; and
c) adjusting the sectors included in the paging zone based on criteria stored for said sector.

2. The method as claimed in claim 1 wherein step c comprises adjusting the paging zone by adding or subtracting specific sectors based on said criteria.

3. The method as claimed in claim 2 wherein said criteria depends on such factors as geographic features, congestion, population density and expected rate of movement.

4. The method as claimed in claim 1 wherein said criteria includes an offset distance and said step of adjusting comprises including sectors located within a distance from said sector equal to said determined distance modified by said offset distance.

5. The method as claimed in claim 4 wherein said offset distance can be positive or negative.

6. The method as claimed in claim 2 wherein said criteria includes an offset distance and said step of adjusting comprises including sectors located within a distance from said sector equal to said determined distance modified by said offset distance.

7. The method as claimed in claim 3 wherein said criteria includes an offset distance and said step of adjusting comprises including sectors located within a distance from said sector equal to said determined distance modified by said offset distance.

8. The method as claimed in claim 6 wherein said offset distance can be positive or negative.

9. The method as claimed in claim 7 wherein said offset distance can be positive or negative.

10. A method of paging a mobile terminal in a radio access network comprising:
a) processing a location update message from said terminal received at a sector in said network;
b) determining a paging zone for said terminal based on configuration information for said sector, said configuration information including a Route Update radius, paging zone radius offset, and selected sectors; and
c) broadcasting a page to said terminal in each sector in said paging zone.

11. The method as claimed in claim 10 wherein said selected sectors can be added or subtracted.

12. The method as claimed in claim 11 wherein said selected sectors are selected based on such factors as geographic features, congestion, population density and expected rate of movement.

13. The method as claimed in claim 10 wherein said configuration information includes additional information for enlarging the paging zone, and said method further comprises:
d) determining a larger paging zone based on said additional information; and
e) broadcasting a second page to said terminal in each sector in said larger paging zone if no reply is received from said terminal after a specified period of time after broadcasting the page in step c.

14. A System for paging a mobile terminal in a radio access network (RAN), said RAN including a processor and software instructions stored on a machine-readable medium, which, when executed by said processor, causes said processor to carry out method steps comprising:
a) processing a location update message from said terminal received at a sector in said network;
b) determining a paging zone for said terminal based on configuration information for said sector said configuration information including a Route Update radius paging zone radius offset, and selected sectors; and
c) broadcasting a page to said terminal in each sector in said paging zone.

15. The system as claimed in claim 14 wherein said selected sectors can be added or subtracted.

16. The system as claimed in claim 15 wherein said selected sectors are selected based on such factors as geographic features, congestion, population density and expected rate of movement.

17. The system as claimed in claim 14 wherein said configuration information includes additional information for enlarging the paging zone, and said method further comprises:
d) determining a larger paging zone based on said additional information; and
e) broadcasting a second page to said terminal in each sector in said larger paging zone if no reply is received from said terminal after a specified period of time after broadcasting the page in step c.

18. The system as claimed in claim 14 wherein step (b) comprises
i) including in the paging zone the sector which receives the last location update from said terminal;
ii) including in the paging zone sectors located within a determined distance from said sector; and
iii) adjusting the sectors included in the paging zone based on criteria stored for said sector.

19. The system as claimed in claim 18 wherein step (c) comprises adjusting the paging zone by adding or subtracting specific sectors based on said criteria.

20. The system as claimed in claim 18 wherein said criteria includes an offset distance and said step of adjusting comprises including sectors located within a distance from said sector equal to said determined distance modified by said offset distance.
